(19) United States
(12) Patent Application Publication
(10) Pub. No.: US 2014/0304127 A1
(43) Pub. Date: Oct. 9, 2014

(54) Return Receipt Tracking

(71) Applicant: THANGARAJ KAROL STUART, Hurst, TX (US)

(72) Inventor: THANGARAJ KAROL STUART, Hurst, TX (US)

(21) Appl. No.: 13/855,725

(22) Filed: Apr. 3, 2013

(51) Int. Cl. G06Q 40/00

(52) U.S. Cl. CPC G06Q 40/12
USPC 705/30

(57) ABSTRACT

A system and method for capturing, uploading, storing, retrieving and analyzing purchase receipts. The system and method may be implemented via a number of mechanisms, including an internet-accessible website, a stand-alone desktop application, a mobile application or some combination thereof. The in-person return of a product can be done using the receipt stored on the Mobile device, rather than carrying a physical paper receipt. The GPS location of the receipt capture point is stored and can be provided as a proof for paper receipt during tax filing audit and marketing of coupons around that location.

### TECHNICAL FIELD OF THE INVENTION

The present disclosure relates generally to storage, retrieval and analysis of purchase data, and particularly to certain systems and methods of capturing, storing and analyzing purchase receipts.

### BACKGROUND OF THE INVENTION

In the course of buying and selling retail goods and services, it is common for a vendor to generate a paper “receipt” documenting the details of the transaction. The paper receipt will generally reflect the identity of the vendor, the good or services purchased, the time and date of the transaction, the amount of the transaction and the form of payment tendered.

### SUMMARY OF THE INVENTION

The present disclosure provides certain versatile systems and methods for capturing, uploading, storing, retrieving and analyzing purchase receipts.

The systems and methods may be provided online in the form of an internet-accessible website capable of receiving and storing images of purchase receipts. In certain embodiments, the systems and methods may be provided in the form of a mobile application running on a handheld mobile device.

Two key features of the receipt storing is that (i) The in-person return of a product can be done using the receipt stored on the Mobile device, rather than carrying a physical paper receipt. (ii) The GPS location of the receipt capture point is stored and can be provided as a proof for paper receipt during tax filing audit and marketing of coupons around that location.

Other features and advantages of the present disclosure will be apparent to those of ordinary skill in the art upon reference to the following detailed description taken in conjunction with the accompanying drawings.

### BRIEF DESCRIPTION OF THE DRAWINGS

For a better understanding of the disclosure, and to show by way of example how the same may be carried into effect, reference is now made to the detailed description along with the accompanying figures in which corresponding numerals in the different figures refer to corresponding parts and in which:

FIG. 1 depicts an Inbox Page according to an embodiment of the present disclosure;

FIG. 2 depicts an Edit Profile Page according to an embodiment of the present disclosure;

FIG. 3 depicts a Bulk Upload Page according to an embodiment of the present disclosure;

FIG. 4 depicts a Create/Upload Receipts Page;

FIG. 5 depicts an Add Receipt Page according to certain embodiments of the present system and method;

FIG. 6 depicts a MyCategory Page according to certain embodiments of the present disclosure;

FIG. 7 depicts a Reports Page according to certain embodiments of the present disclosure;

FIG. 8 depicts a mobile inbox user interface for a mobile application according to certain embodiments;

FIG. 9 depicts a Mobile Scan & Upload interface for a mobile application according to certain embodiments;

FIG. 10 depicts a Mobile Report interface for a mobile application according to certain embodiments;

FIG. 11 depicts a Mobile Receipt GPS Location Capture interface for a mobile application according to certain embodiments;

FIG. 12 depicts a Mobile Receipt Search interface for a mobile application according to certain embodiments;

FIG. 13 depicts a Mobile Edit Receipt interface for a mobile application according to certain embodiments;

FIG. 14 depicts a flow chart laying out the general flow of the application;

FIG. 15 depicts a flowchart for the Inbox Page of the internet-accessible website; and

FIG. 16 depicts a flowchart representing the flow of the mobile application.

### DETAILED DESCRIPTION OF THE INVENTION

While the making and using of various embodiments of the present disclosure are discussed in detail below, it should be appreciated that the present disclosure provides many applicable inventive concepts, which can be embodied in a wide variety of specific contexts. The disclosure is primarily described and illustrated hereinafter in conjunction with various embodiments of the presently-described systems and methods. The specific embodiments discussed herein are, however, merely illustrative of specific ways to make and use the disclosure and do not limit the scope of the disclosure.

The present disclosure relates to an application that stores receipts and enables a user to track their own spending patterns. Whether a user needs to track household finances, to keep track of business costs or maximize an income tax refund, the systems and methods of the present disclosure serve to facilitate the effort.

The systems and methods of the present disclosure may be configured to organize expenses automatically, so as to reduce the need for long-term retention of paper receipts. The systems and methods may also be configured to facilitate rapid retrieval of the receipt contents. If there is a need to prove a purchase, return an item or backup a deduction, the systems and methods of the present disclosure can be configured to facilitate such tasks.

Receipt images can be captured using any one of a variety of devices including smartphones, scanners or digital cameras. The images can then be uploaded via the systems and methods disclosed herein. The images can be stored in the server and displayed for the user on demand.

In addition to storage of the receipt images, the present systems and methods are operable to generate useful reports detailing expenditures. The present systems and methods include multiple user interface pages through which the user may manage individual receipts as well as overall revenue and expenses.

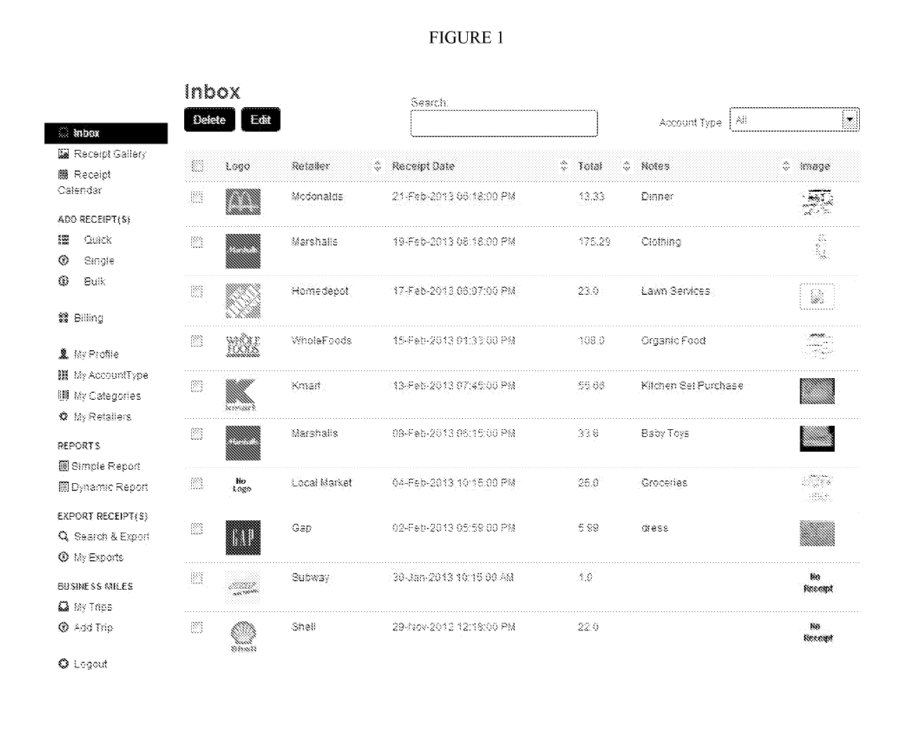

FIG. 1 depicts an Inbox Page according to an embodiment of the present disclosure. Via this Inbox Page, a user can view a plurality of receipts with details for each. Detailed information for receipts may be provided with the following field values:
A. Retailer details;
B. Date of the receipt;
C. Receipt amount;
D. Notes relating to the receipt;
E. Receipt category; and
F. A thumbnail view of the receipt.

Via the Inbox Page a user can edit or delete a receipt. An expanded view of the receipt image can be opened by clicking the receipt image in the image column of Inbox Page.

A user can sort values using the “Account Type” select box, giving the user various options for filtering or sorting the Inbox Page display, including:
A. All Receipts
B. Personal Receipts
C. Business Receipts

According to certain embodiments, the user interface will automatically redirect to the “Upload Receipt” function whenever the user clicks the appropriate link provided in the Inbox table. The appropriate values are then automatically populated in the Upload Receipt page.

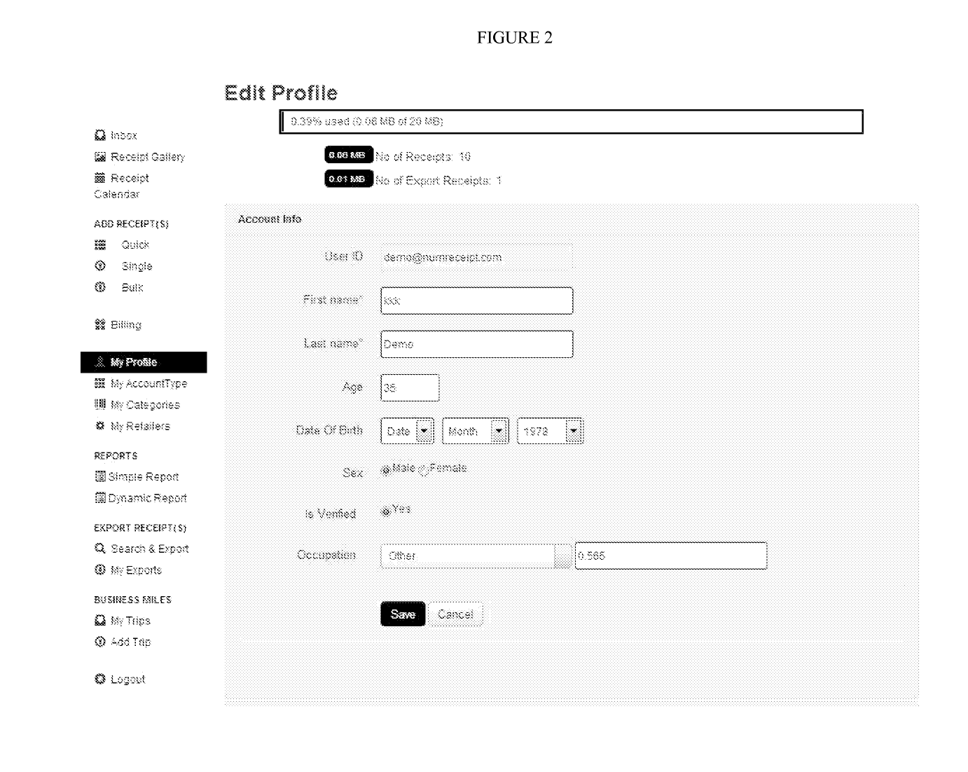

FIG. 2 depicts an Edit Profile Page according to an embodiment of the present disclosure. Via this page, a user can modify their profile details. The following values may be editable:
A. First Name
B. Last Name
C. Age
D. Sex
E. Password and Confirm-Password

After appropriate values are provided via the Edit Profile Page, clicking “save” will update the profile details with the new values provided.

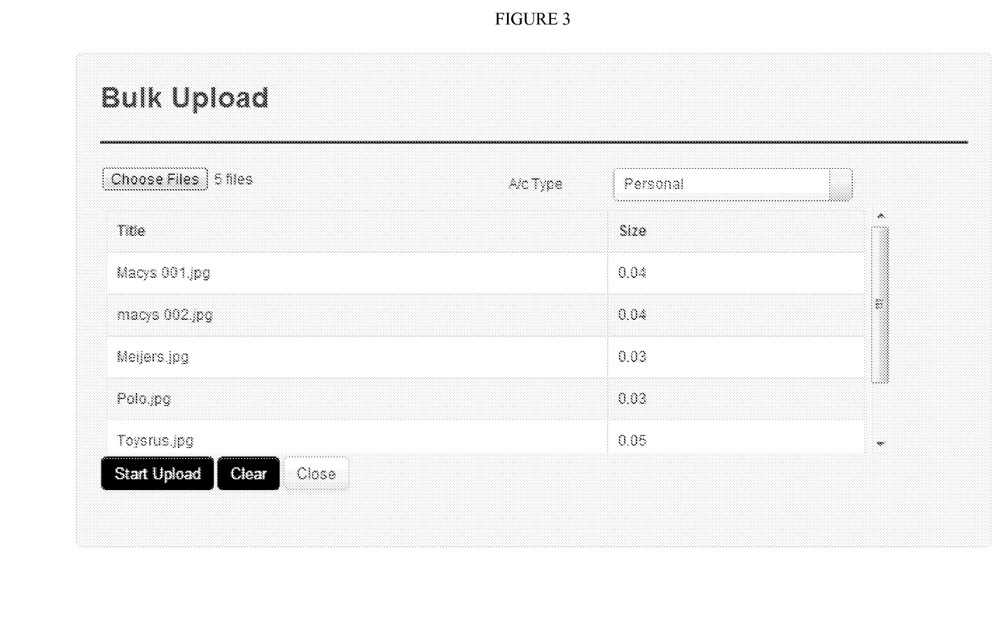

FIG. 3 depicts a Bulk Upload Page according to an embodiment of the present disclosure. Bulk Upload provides a pop-up window through which the user may upload any number of receipt images. Whenever the user clicks on the Browse button or Choose button, the user is provided with a browse window through which the user can select the appropriate files from the local device.

Selected file name and file size are populated in a table. Total size and the number of files are displayed in the footer of the table.

After the receipt image files are selected, the user may click ‘Start Upload’ to begin the upload process. According to certain embodiments, the upload process may proceed as a background process while the user performs other tasks. Once upload is complete, the uploaded receipt files may be displayed in the Inbox Page.

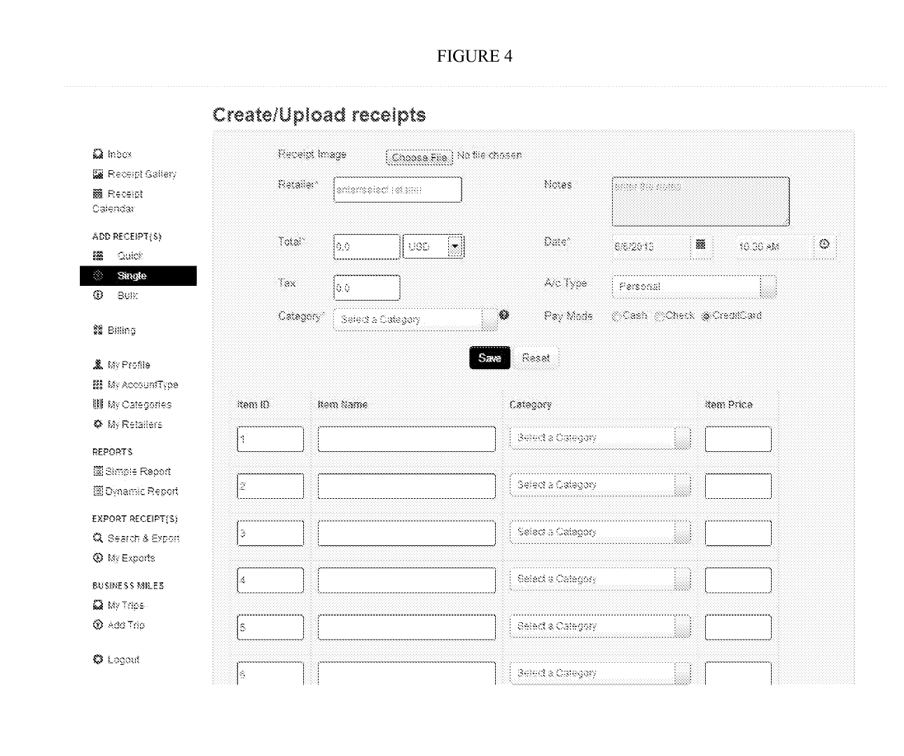

FIG. 4 depicts a Create/Upload Receipts Page. Using this page a user can create a new receipt or upload a new receipt with options such as:
A. Browse a receipt image file from the user's device
B. Add Retailer Details
C. Add Notes for the receipt
D. Add the total expense of the receipt
E. Add the Date & time of the receipt
F. Add Tax paid on the receipt
G. Identify Account type (e.g., Personal or Business)
H. Assign the Receipt to a Category
I. Identify the Payment mode for the receipt

After entry of some or all of the above details, values can be entered in a table for one or more of the following fields:
A. Item ID
B. Item Name
C. Select Category value
D. Item Price

The user may be provided with a preview column next to the table for the receipt image file uploaded. In this preview, the user may be provided with some functionality to rotate, maximize and minimize the receipt image file. After the data is entered, the user may save to the server the values associated with the uploaded receipt.

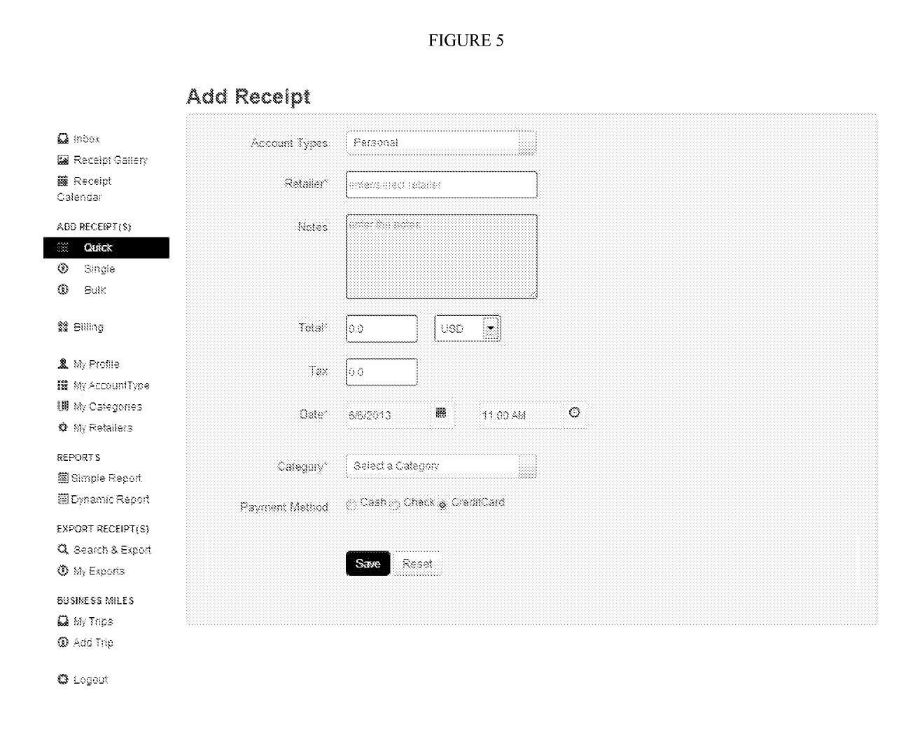

FIG. 5 depicts a manual Add Receipt Page according to certain embodiments of the present system and method. Using the Add Receipt Page, a user may add certain receipt details manually; such details that may include:
A. Account type (e.g., Personal or Business)
B. Retailer Detail
C. Notes for the receipt
D. Total expense of the receipt
E. Tax paid on the receipt
F. Date & time of the receipt issue
G. Receipt Category
H. Payment mode for the receipt

After providing these details, the user may save the receipt to the server.

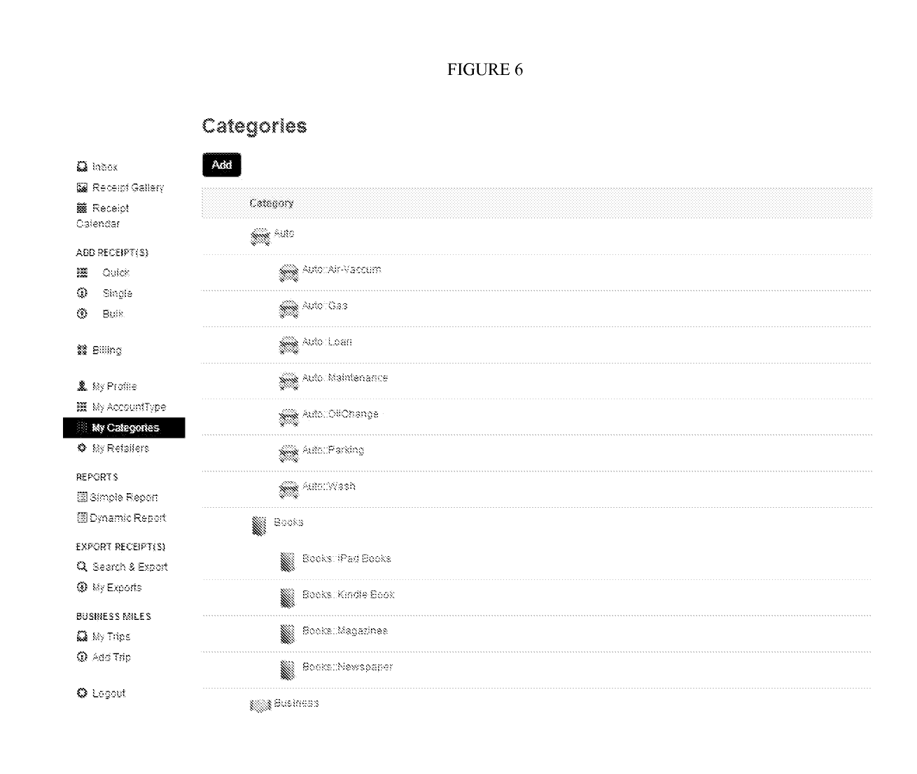

FIG. 6 depicts a MyCategory Page according to certain embodiments of the present disclosure. The MyCategory Page is a simple page that shows a variety of category values, which may include admin categories as well as user categories. Examples of admin categories include:

A. Auto
B. Books
C. Business
D. BusinessTrips
E. CoffeeShop
F. Clothing
G. Electronics
H. Gifts
I. Entertainment
J. Groceries
K. Home
L. Healthcare
M. Holidays
N. Insurance
O. Kids
P. Marriage
Q. Miscellaneous
R. Personal
S. Restaurants
T. ReturnReceipts
U. Travel
V. Vacation

The user may sort the category field column by clicking the header. By selecting ‘Show,’ the category values are displayed in the table. A search option may also be provided via the search textbox in the header. Functions such as Add New Category, Edit Category and Delete Category may be provided in the table, as follows:
ADD: By clicking the “Add” button, the user may be provided with a popup window in which category values may be entered. The user may then enter the sub-category value in a textbox and then click ‘Save’ to store the category in the user's category list. The information may update in the MyCategory page, as well.
EDIT: Edit functionality may be provided via an inline edit mechanism. The user may edit the information by clicking on the appropriate category.
DELETE: Delete functionality may be used to delete a selected category value listed on the MyCategory Page.

In certain embodiments, the user may be provided with limited access to edit and delete specific categories assigned to them. Categories not assigned to a user may not be editable or open to deletion by that user.

The system and method may also include a MyRetailer Page which is very similar to the MyCategory page with few modifications. The MyRetailer Page may be a simple page to display certain retailer-related values. The MyCategory Page may including retailers identified with the administrator as well as those identified with one or more individual users.

The user may sort the category field column by clicking the retailer header. Using the select box ‘Show,’ retailer values in the table may be displayed. Search functionality may also be provided. Functions such as Add New Retailer and Edit Retailer may be provided, as described above.

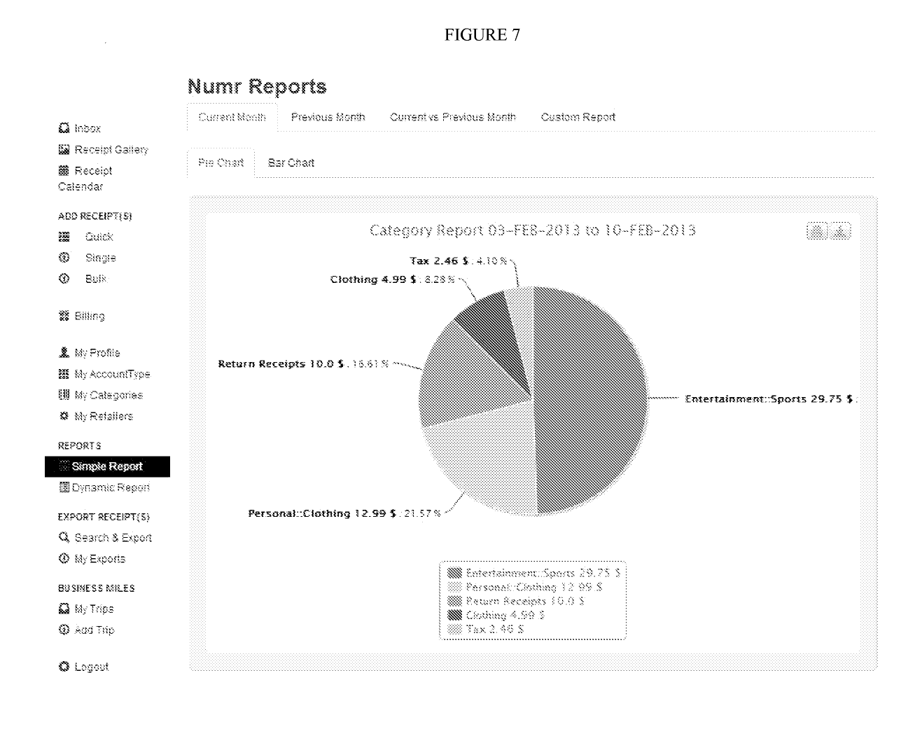

FIG. 7 depicts a Reports Page according to certain embodiments of the present disclosure. Via the Reports Page, the user can view one or more diagrammatical images representing expenditures in a straightforward visual format. The reports displayed may take a number of forms, including pie charts, bar charts and line charts, as examples.

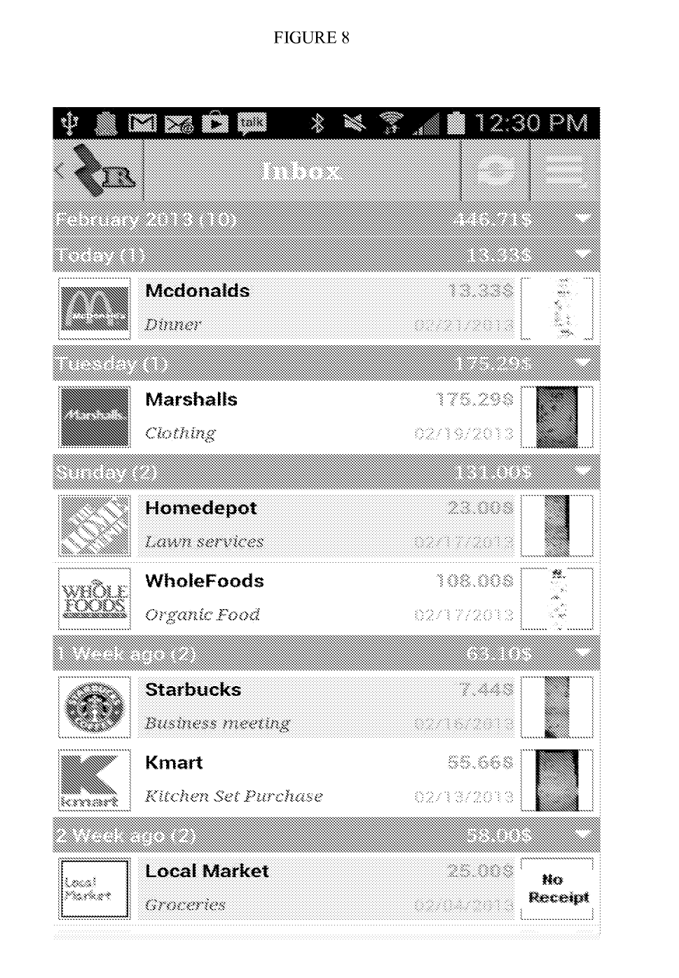

FIG. 8 depicts a user inbox interface for a mobile application according to certain embodiments. The user interface is for a mobile device, which may be a tablet or cellular phone running an Apple, Android, Blackberry or Microsoft operating system, as examples. Using the mobile application, the user can capture images of receipts and upload them to the server.

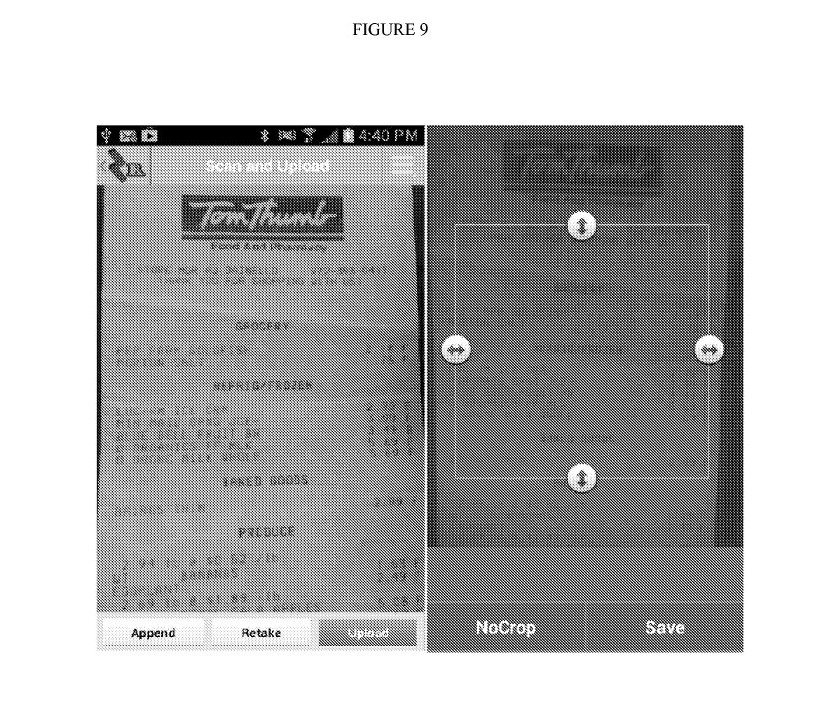

FIG. 9 depicts the user interface to capture an image of a receipt using their device camera and then upload that scanned image to the server using the “Scan & Upload” page of the application. The user is provided with certain functionality regarding this scan & upload process. After scanning, a user may:
A. Crop the scanned image;
B. Save the image; or,
C. Retake a new image.

Using the Crop option, the user may crop the scanned image as necessary to remove extraneous content. Selecting the Save option takes the user to the Upload page, through which the user may access upload receipt functionality.

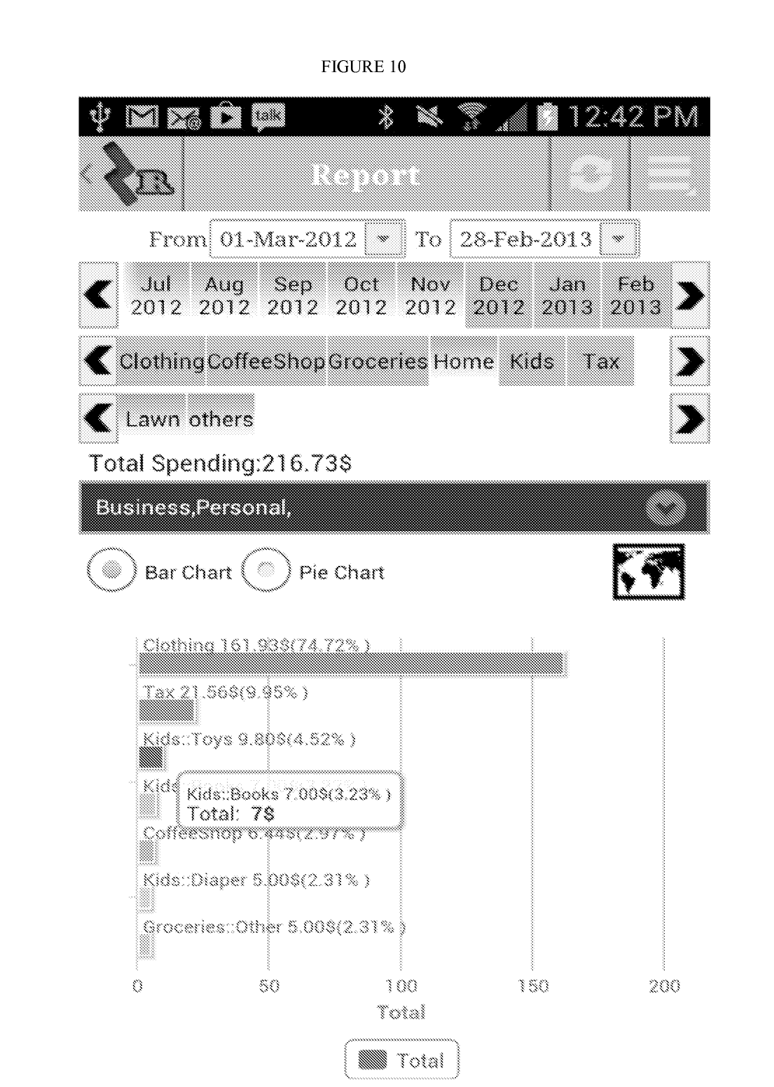

FIG. 10 depicts a user report interface for a mobile application according to certain embodiments. Using the mobile application, the user can generate report and can monitor the amount spent on each categories and on each retailers.

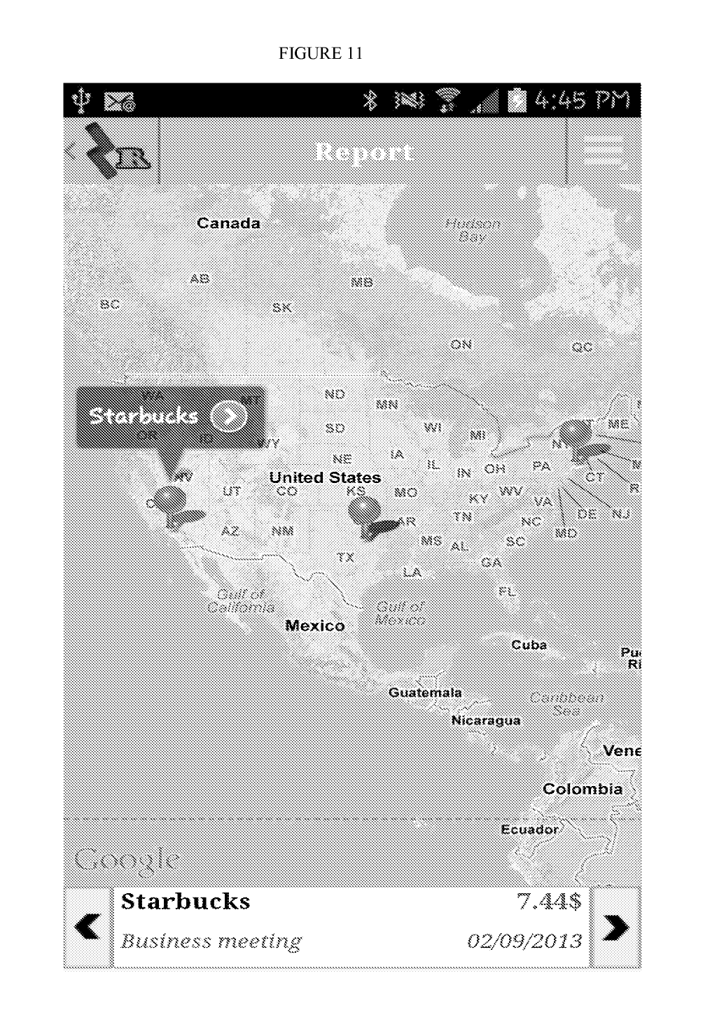

FIG. 11 depicts a report interface for a GPS location capture report for a mobile application according to certain embodiments. Using the mobile application, the user can generate GPS report and can monitor the amount spent on different location. If user travels to different places, they can zoom to a particular place and can see the total spent just on the visible GPS points.

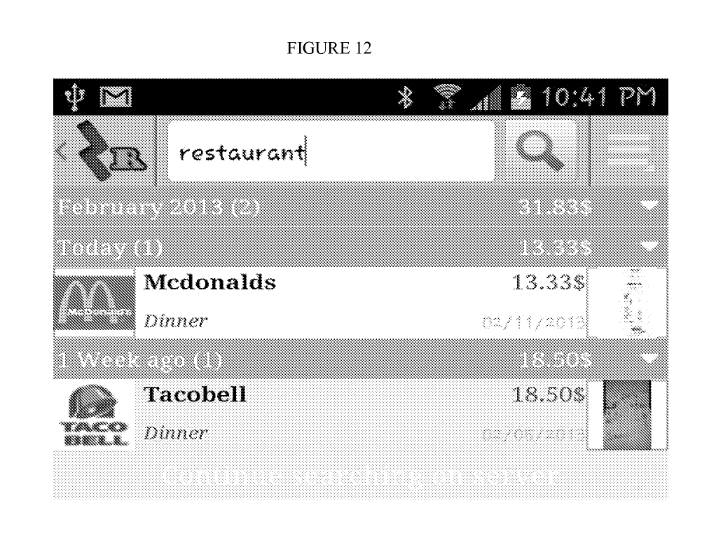

FIG. 12 depicts a search interface for a mobile application according to certain embodiments. Using the mobile application, the user can search for a receipt and can pull it to show it as a proof to return a receipt. User can also search by category, notes or Retailer name

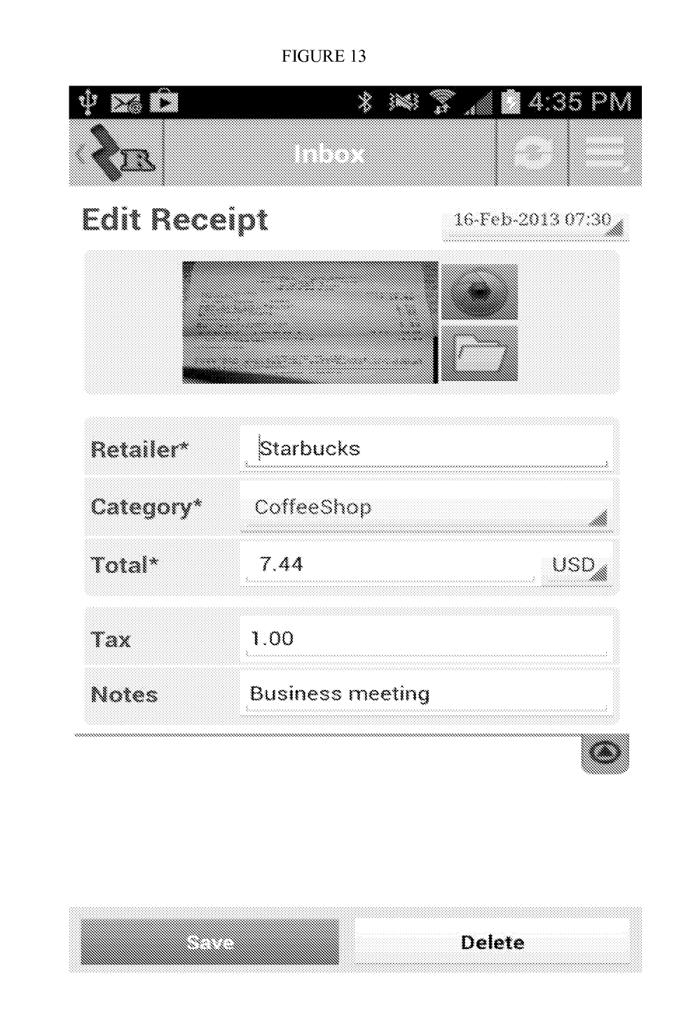

FIG. 13 depicts a edit receipt interface for a mobile application according to certain embodiments. Using the mobile application, the user can edit each receipt and change the retailer, total, tax, category, item price and notes.

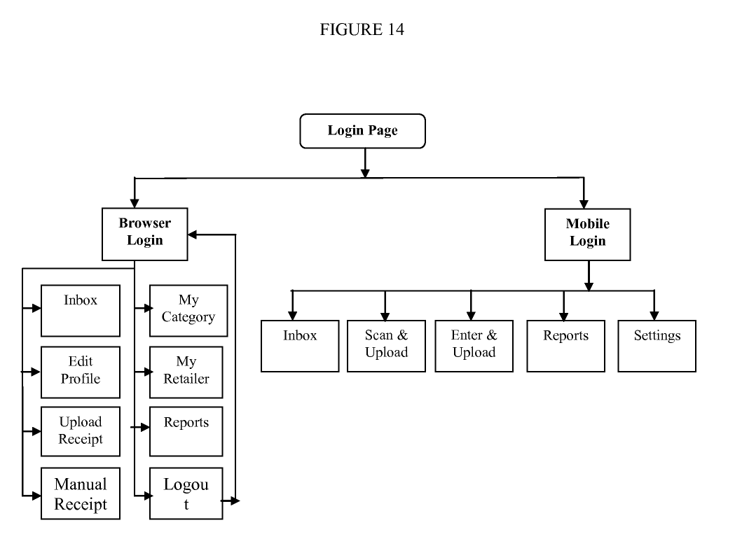

FIG. 14 depicts a flow chart laying out the general flow of the application.

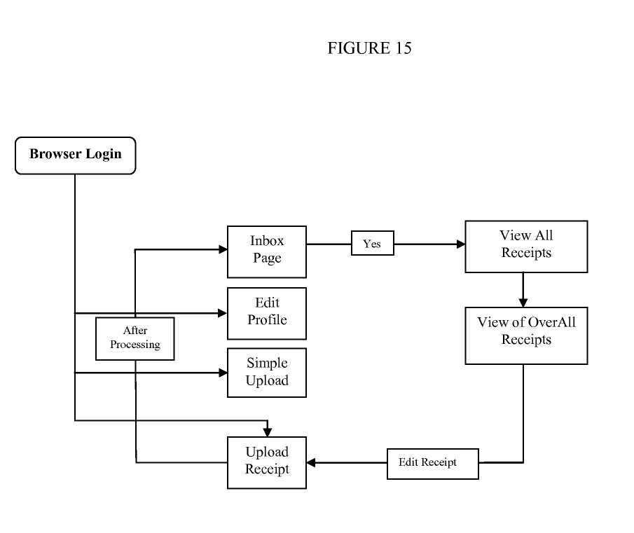

FIG. 15 depicts a flowchart for the Inbox Page of the internet-accessible website.

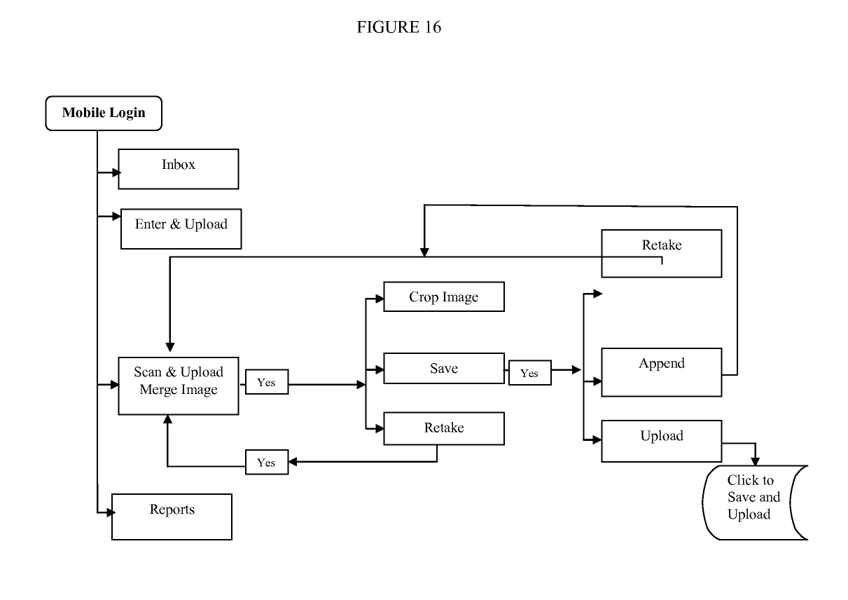

FIG. 16 depicts a flowchart representing the flow of the mobile application.

The above-described system and method may be implemented via a wide variety of software tools and resources. In one embodiment, the system may use a MongoDB database system owing to its simplicity and feasibility for this application. Mongo DB is characterized by a number of potential advantages, including scalability, open source architecture, NoSQL database structure, document-oriented storage (JSON-Style document storage,) quick retrieval of data, easy replication, rich queries, fly indexes which can be created with a single command and cool data structure available with realm of key-value.

As those of skill in the art will appreciate, the terminology employed in Mongo DB varies somewhat from that used in SQL. “Tables” in SQL are referred to as “Collections” in Mongo DB. In general, however, technical terms employed in connection with MongoDB are similar to those employed in connection with SQL. Query string format is somewhat modified as compared to SQL.

In certain embodiments, the present systems and methods may employ a Java Spring Framework for implementation. Accordingly, certain portions of the code may be written in separate layers such as a controller layer for handling requests, a Data Access Object (DAO) layer for data base access, a service layer for servicing and an implementation layer for implementing the requests and generating responses.

Although certain embodiments of the present systems and methods may employ Mongo DB and/or a Java Spring Framework, there is nothing within the overall spirit and scope of the present disclosure limiting their use to any particular database system or development framework.

Similar embellishments, and various combinations thereof, are all comprehended by the present disclosure. In fact, all embodiments described herein are presented for purposes of illustration and explanation only. The specific compositions, configurations, orientations and operations of various features, portions and members may be provided in a number of ways in accordance with the present disclosure.

Thus, the embodiments and examples set forth herein are presented to best explain the present disclosure and its practical application and to thereby enable those skilled in the art to make and utilize the disclosure. As previously explained, those skilled in the art will recognize that the foregoing description and examples have been presented for the purpose of illustration and example only. The description as set forth is not intended to be exhaustive or to limit the disclosure to the precise form disclosed. Many modifications and variations are possible in light of the above teaching without departing from the spirit and scope of the following claims.

1. A method for tracking expenses, comprising:
receiving an image of relating to a transaction;
initiating storage of the image in a database;
receiving transaction data relating to the transaction; and
initiating storage of at least a portion of the transaction data in a database.

2. The method of claim 1, wherein the image is a scan of a purchase receipt.

3. The method of claim 1, wherein the transaction data comprises a purchase price.

4. The method of claim 1, wherein the transaction data comprises tax information.

5. The method of claim 1, wherein at least one of the image and the transaction data are received via a wireless link.

6. The method of claim 1, wherein the image is a camera image.

7. The method of claim 1, wherein the image is received from a handheld wireless device via a cellular network.

8. The method of claim 1, further comprising the steps of:
receiving a retrieve instruction and
initiating a retrieval process to retrieve the image.

9. The method of claim 1, further comprising the steps of:
receiving a print instruction and
initiating a print process to print a hardcopy of the image.

10. The method of claim 1, wherein the transaction data comprises time and date information and wherein the method further comprises the steps of:
setting an action deadline to fall at a specified time after the time and date of the transaction and
generating a user alert prior to the deadline.

11. A system for tracking expenses, comprising:
a module for receiving an image of relating to a transaction;
a module for initiating storage of the image in a database;
a module for receiving transaction data relating to the transaction; and
a module for initiating storage of at least a portion of the transaction data in a database.

12. The system of claim 11, wherein the image is a scan of a purchase receipt.

13. The system of claim 11, wherein the transaction data comprises a purchase price.

14. The system of claim 11, wherein the transaction data comprises tax information.

15. The system of claim 11, wherein at least one of the image and the transaction data are received via a wireless link.

16. The system of claim 11, wherein the image is a camera image.

17. The system of claim 11, wherein the image is received from a handheld wireless device via a cellular network.

18. The method of claim 11, further comprising:
a user interface operable to receive a retrieve instruction;
a database operable to retrieve the image from the database and
a display operable to display the image.

19. The system of claim 11, further comprising:
a user interface operable to receive a print instruction and
a print interface operable to initiate the printing of a hardcopy of the image.

20. The system of claim 11, wherein the transaction data comprises time and date information and wherein the system further comprises:
a scheduler operable to set an action deadline to fall at a specified time after the time and date of the transaction and
an alarm operable to generate a user alert prior to the deadline.
